(19) United States
(12) Patent Application Publication
(10) Pub. No.: US 2006/0206248 A1
(43) Pub. Date: Sep. 14, 2006

(54) System and method for calculating vehicle service policies

(76) Inventors: Charles Noussias, Carson, CA (US); Jesse Arias, Carson, CA (US)

Correspondence Address: BUCHANAN, INGERSOLL & ROONEY PC, POST OFFICE BOX 1404, ALEXANDRIA, VA, 22313-1404, US

(21) Appl. No.: 11/078,133

(22) Filed: Mar. 11, 2005

(51) Int. Cl. G01M 17/00

(52) U.S. Cl. 701/29; 701/35

(57) ABSTRACT

In accordance with the present invention, there is provided a method of calculating a service policy for a vehicle. The method comprises determining a number of miles driven by the vehicle and the condition of the vehicle. Furthermore, a mileage range for the vehicle is determined. The cost of the service police is calculated by a computer in response to the condition of the vehicle, the number of miles driven by the vehicle and the mileage range.

### FIELD OF THE INVENTION

The present invention generally relates to calculating pricing and needed services under vehicle maintenance policies.

### BACKGROUND OF THE INVENTION

In order to maintain a vehicle in peak performance, the vehicle must be regularly serviced. By providing regular service (e.g., changing the fluids, replacing worn belts and parts, identifying problems), the life of the vehicle can be greatly increased.

Typically, an owner of a vehicle can buy an extended warranty that covers the cost of repairing the vehicle. For example, when buying the vehicle, the seller of the vehicle will offer the buyer the extended warranty for a prescribed fee. The fee is usually based on the type of vehicle, age and number of miles driven.

With just information about the type of vehicle and visual condition of the vehicle, it is not possible to determine whether there will be any major catastrophic failures of the vehicle. The dealer is betting that the vehicle is in good enough condition that major service will not be required. However, often times this is not the case, and the dealer will have to pay a substantial sum to cover warranty repairs.

Furthermore, the extended warranty does not provide regular services for the vehicle. The owner of the vehicle must pay for service in order to keep the vehicle in running condition. Accordingly, if the vehicle is not serviced properly, the incidence of failure of parts increases. The dealer must then assume responsibility of these repairs with the extended warranty.

Car repair can also be an intimidating experience for some people. Many car owners are not mechanically inclined such that they must trust the recommendations of the mechanic working on their vehicle. Many owners do not have the knowledge needed to determine if the mechanic is truthful about the repairs that need to be performed.

The present invention addresses the above-mentioned deficiencies in car repairs by providing a system and method for calculating the cost of an vehicle maintenance policy that covers routine maintenance, as well as repairs to the vehicle. The system and method provides a computerized manner of calculating the cost of repairs and maintenance based on the condition of the vehicle. In this regard, the present invention provides a system that estimates the cost of maintaining the vehicle and the cost of providing a vehicle policy to the owner of the vehicle.

### SUMMARY OF THE INVENTION

In accordance with the present invention, there is provided a method of calculating a service policy for a vehicle. The method comprises determining a number of miles driven by the vehicle and the condition of the vehicle. Furthermore, a mileage range for the vehicle is determined. The cost of the service police is calculated by a computer in response to the condition of the vehicle, the number of miles driven by the vehicle and the mileage range.

In the preferred embodiment, the condition of the vehicle is determined by a visual inspection and analyzing the fluids of the vehicle. The number of miles driven by the vehicle is determined by calculating the frequency of trips that the vehicle is driven. The mileage range of the vehicle is correlated to the number of miles driven by the vehicle and includes the number of services to be performed on the vehicle.

The cost of the policy can be further calculated to include the cost of a deductible (if any). Furthermore the cost of the policy can include extended coverage for catastrophic failure. Specifically, under a normal policy failure to the engine and transmission may not be covered. The extended coverage provides compensation for these failures. The cost of the extended coverage can be calculated by analyzing the fluids from the engine and the transmission.

### BRIEF DESCRIPTION OF THE DRAWING FIGURES

These, as well as other features of the present invention, will become more apparent upon reference to the drawings wherein:

FIG. 1 is a flowchart illustrating a method of calculating a service policy of a vehicle.

### DETAILED DESCRIPTION OF THE INVENTION

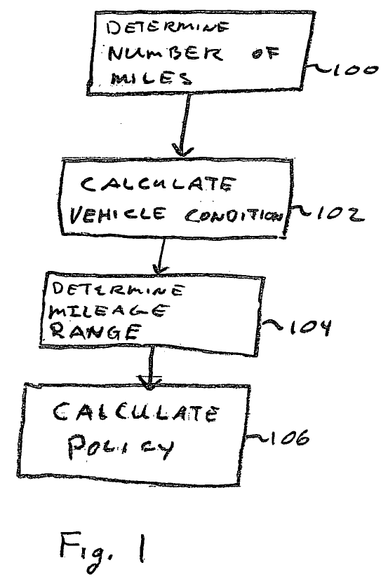

Referring now to the drawings wherein the showings are for purposes of illustrating preferred embodiments of the present invention only, and not for purposes of limiting the same, FIG. 1 illustrates a method of calculating a vehicle maintenance policy for the service of a motor vehicle such as a car. The steps illustrated by FIG. 1 can be performed on a multi-purpose computer by a user entering information. It will be recognized by those of ordinary skill in the art that the computer may be networked with other computers in a typical fashion in order to share information.

In step 100, the number of miles the policy needs to be written for is determined. Typically, the policy will be written for a year in duration and will take into account the numbers of miles driven by the owner of the vehicle, number of days worked using the vehicle, number of other trips the owner used for the vehicle and time taken off for vacation. A factor such as 25% can be added to the mileage in order to account for other usage of the vehicle. The policy is written in increments of 5,000 miles and should be rounded up to the next increment.

Referring to FIG. 1, in step 102, the condition of the vehicle is assessed. The vehicle will be put through a visual inspection, as well as an oil analysis. The visual inspection is performed by a trained technician specializing in that system for the vehicle and who will provide a grade for that system. The systems include the charging system, brake system, shock and suspension system, ignition system, air conditioning system, fuel system, air filtration system, emissions system, cooling system and transmission system.

Each of the systems will be issued a code (A, B, C, D, F, or U). An (A) code represents a system in excellent condition needing no additional service to bring it up to peek levels of performance. Whereas an (F) code represents a system that is in need of maximum service to bring the system to a peek level of performance. An (F) code can also be a system that that needs major parts replacement. A (U) code is issued for any system that cannot be cost effectively replaced and/or efficiently maintained.

The codes are used to add additional amounts to the policy to cover the costs of bringing all the systems of the vehicle up the highest level of performance at the start of the policy period. The codes are inputted into the computer after the visual inspection. If any of the systems received a (U) code, the vehicle will be unable to be covered by a policy.

The policy that is provided covers the cost of breakdowns, roadside assistance and towing within a prescribed area. Furthermore, the policy covers all OEM recommended service requirements for the vehicle during that service period. The cost of all fluid changes, inspections and required services necessary to keep the vehicle in peak performance are also covered by the policy. Brakes and bearings including CV joints when applicable are covered. The policy may also include the cost of a smog certification and inspection and service of all external systems of the entire power train. The cost of vehicle registration and car detailing may also be covered by the policy.

The basic policy does not cover catastrophic engine or transmission failure. However coverage for these items may be purchased at the time of writing the policy. By utilizing an oil sample from the vehicle, the condition of the engine can be determined. Specifically, the engine oil sample can determine engine wear factors (even or abnormal wear patterns), actual miles on the engine, estimated residual life left on the engine, anticipated problems ready to occur on the engine, overly warn internal parts.

Based on the oil sample, each vehicle will be issued a code of (A, B, C, D or F) representing the condition of the engine. An (A) code indicates that the engine is at or above peak performance conditions and the decision to purchase additional coverage is up to the client (i.e., owner of the vehicle). If the additional coverage is purchased a slight amount might be added to the standard policy as well as a required deductible amount payable at the time of failure.

If a (B) code is issued, then the engine is in normal or good condition internally. The client has the option of purchasing the additional coverage. The cost of the policy and the deductible will be increased and will be higher than the amount for an (A) condition engine.

If a (C) code is issued, the engine is in a normal or slightly below normal condition internally. The client still has the option of purchasing additional protection. Again, the cost of the policy and the deductible will be increased and be higher than the amount for the (B) condition.

A (D) code indicates that the engine has a below normal wear pattern and one or more internal parts are abnormally worn. The client has the option of purchasing additional coverage at the time the policy is written and is reminded that catastrophic engine failure is not covered by the standard policy. The cost of the policy and the deductible are increased if the additional coverage is purchased.

An (F) code represents that the engine wear is below normal and multiple internal parts are heavily worn. A policy will not be written for the vehicle without additional coverage for catastrophic engine failure.

The deductible amount is determined to adequately cover the wholesale cost of the unit or parts needed to restore the vehicle to peek performance level immediately. The information can be retrieved from a vehicle parts database and put into writing as an estimate of whet these costs should be if failure occurs. The deductible can be paid in advance if the client chooses.

It will be recognized that in addition to the oil analysis, a transmission fluid analysis can also be performed. The fluid from the torque converter of the vehicle can be used for the same grading. As such, the same coding procedure for the transmission can also be made in order determine the cost of additional coverage and deductible for catastrophic failure of the transmission.

After the vehicle condition is determined, then a mileage range is determined in step 104. The starting mileage determines the OEM recommended services for the vehicle at the time the policy is written. Previous services for the vehicle need to be determined in order to determine the condition of the vehicle. If previous services have not been performed, then additional amounts may be added to the cost of the policy. By reviewing the services performed on the vehicle, it is possible to develop a pattern of consistency with respect to the vehicles service. By determining the consistency of the policy the overall condition of the vehicle can be determined.

After the starting mileage is calculated, then a range of miles based on the starting and projected ending mileage is determined. The range of miles is used to determine the services required during the coverage period of the policy. Typically, these are services recommended by the manufacturer of the vehicle. The cost of the policy can be adjusted according to the services needed.

Referring to FIG. 1, the actual cost of the policy is calculated in step 106. The cost of the policy is calculated based on the information determined in steps 100, 102 and 104. Based on the total number of miles driven calculated in step 100, the length of the policy is determined. Specifically, the total number of miles is divided by 5,000 to determine the policy length because the minimum policy increment is 5,000 miles. Additionally, this number will represent the number of times the vehicle will be serviced (i.e., each 5,000 miles).

Based on the overall condition of the vehicle determined in step 102, the cost of bringing the vehicle up to peak performance is determined in step 106. The grade assigned by the technicians is used as a determining factor as to the condition of the vehicle. Furthermore, the clients history (i.e., repair and claim history) is determined in order to further calculate the amount of the policy because this is another indication of the vehicle's condition.

The mileage range found in step 104 is used in calculating the cost of the policy in step 106. The total number of visits, as well as the cost to upgrade the vehicle to peak performance by the mechanics is used in the calculation of the policy.

In addition to the foregoing, the cost of added coverage for the engine and the transmission will be added to the cost of the policy in step 106. As previously stated, the cost of the additional coverage and increase in deducible is determined from a fluid analysis of the engine in order to give an estimate of when the engine will experience failure. Based on this information the cost of the policy can be calculated, as well as the recommended deductible.

Additional modifications and improvements of the present invention may also be apparent to those of ordinary skill in the art. Thus, the particular combination of parts described and illustrated herein is intended to represent only certain embodiments of the present invention, and is not intended to serve as limitations of alternative devices within the spirit and scope of the invention.

What is claimed is:

1. A method for calculating a cost of a service policy of a vehicle with a computer, the method comprising the steps of:
determining a number of miles driven by the vehicle;
determining a condition of the vehicle;
determining a mileage range for the vehicle; and
calculating the cost of the service policy with the computer in response to the number of miles driven, the condition of the vehicle and the mileage of the vehicle.

2. The method of claim 1 wherein the condition of the vehicle is determined by visually inspecting the vehicle.

3. The method of claim 2 wherein the condition of the vehicle is determined by analyzing the fluids of the vehicle.

4. The method of claim 1 wherein the number of miles driven by the vehicle is determined by calculating the frequency of trips.

5. The method of claim 1 wherein the mileage range for the vehicle is correlated to the number of miles driven by the vehicle.

6. The method of claim 1 wherein the mileage range of the vehicle includes the number of services to be performed on the vehicle.

7. The method of claim 1 wherein calculating the cost of the policy further comprises calculating the cost of a deductible.

8. The method of claim 1 wherein the cost of the policy further includes extended coverage.

9. The method of claim 8 wherein the cost of the extended coverage is determined from an analysis of the fluids of the vehicle.

10. The method of claim 1 wherein the vehicle is a passenger automobile.
